(19) United States
(12) Patent Application Publication
(10) Pub. No.: US 2010/0028488 A1
(43) Pub. Date: Feb. 4, 2010

(54) ALGAL BIOMEAL-BASED PALATABILITY ENHANCER AND METHOD OF USE AND MANUFACTURE THEREFOR

(76) Inventors: Y. Martin Lo, Ashton, MD (US); Phyllis G. Scalettar, Potomac, MD (US)

Correspondence Address: Saul Ewing LLP (Baltimore);Attn: Patent Docket Clerk, Lockwood Place, 500 East Pratt Street, Suite 900, Baltimore, MD, 21202, US

(21) Appl. No.: 12/442,828

(22) PCT Filed: Sep. 27, 2007
(86) PCT No.: PCT/US07/79684

§ 371 Date: Mar. 25, 2009

Related U.S. Application Data
(60) Provisional application No. 60/827,271, filed on Sep. 28, 2006.

(51) Int. Cl. A23K 1/16; A23K 1/14; A23K 1/18

(52) U.S. Cl. 426/18; 426/61

(57) ABSTRACT

An animal food palatability enhancing composition that includes a manufactured edible substrate comprising a texture; and a delipidated microbial biomeal, wherein the delipidated component comprises about 2% to about 4% docosahexaenoic acid (DHA) by weight and wherein the palatability enhancer improves palatability of animal food products. Also provided is a method for optimizing palatable components of microbial biomeal comprising: fermenting microbial aquaculture products; lysing microbial cells; extracting natant lipids to produce a waste product, wherein the microbial biomeal; elucidating the mechanisms of the chemical constituents in microbial aquaculture products; modifying the microbial biomeal to fit predetermined texture and flavor specifications; and characterizing a nutritional value of the microbial biomeal; wherein formulation of pet food palatable components are modified.

### BACKGROUND

1. Field of the Invention

The embodiments of the invention generally relate to an animal food palatability enhancer and method of use and manufacture therefore, and, more particularly, to a palatability enhancer for feline animal foods.

2. Brief Description of the Related Art

Animal food manufacturers have a business incentive to provide pet food having a high degree of nutritional value, palatability, resistance to bacterial contamination and/or decomposition, and having low production costs. Each of these attributes, in various degrees, is found in the three main categories of pet food: dry, semi-moist, and canned.

The long-standing, multiple processes for developing and producing dry, semi-moist, and canned pet food products and palatants for such, notably cat food, are well known in the art.

In designing foods for companion animals such as cats and dogs, optimal animal health or wellness through good nutrition is an important goal. However, even the most nutritious animal food is of little value if the animal rejects or refuses to eat the food or if the animal's intake of the food is restricted, because it finds the food unpalatable. This problem is especially pronounced with cat food since cats (domestic and exotic) have long been recognized as sporadic or “finicky” eaters, or otherwise excessively selective in what they will consume. Consistent with their requirement for highly palatable food, they generally ignore dried food products in preference to meat and high moisture foods.

Finicky animals, older animals, sick animals, and high energy animals often do not consume enough nutrients to maintain their weight and activity level. Particularly in the case of older animals and sick animals, lack of interest in food and resulting low consumption can result in muscle deterioration, weakness and poor recovery of health, ultimately resulting in hospitalization and/or death of the animal.

Enticing a companion animal to eat can be an expensive and time consuming chore. Particularly for cats, with few exceptions the only way to determine the gastronomic preferences of the animal is by trial and error. As a result, owners frequently change types and brands of food in order to maintain their pets in a healthy and contented condition.

There are a number of processes disclosed in the art for improving the palatability and other characteristics of dry pet food. Known palatability enhancers for low moisture pet foods include various surface coating compositions, applied in aerosol, liquid or dry form and alone or in various combinations. For example, liquid or dry animal digest coatings are widely used to enhance palatability, and animal digest is also used in a liquid combination with phosphoric acid. Palatability also may be enhanced by the application of liquid or dry flavorings as a coating, but flavorants alone have a limited impact on improving palatability. Additionally, foods with varying moisture content, supplements and treats have been developed to encourage animals to eat. However, use of current compositions and methods has proven to be an imperfect solution to the problem of increasing palatability.

Existing knowledge on the development of specialty treats for pets has been unintentionally incomplete since the industry has been relying solely on in-house formulations that are limited in quality. This is mainly due to the short turnaround time during development, while new products often fall “under or near the tree” (as evidenced by the limited flavor varieties) because the pressure of profits outweighs risk-taking, leaving considerable unknowns of the science involved. Consequently, the applicability of new ingredients from specific sources has been greatly hindered, resulting in slim choices for animal caretakers. This invention helps the industry meet the demands of high quality, nutritious, and flavor-rich products.

While those skilled in the art are aware of multiple formulations for preparing such products, there remain problems within the art, notably in addressing the palatability issue. Over the years, various techniques have been used to try to address the continuing challenge and need to improve the palatability of dry and semidry animal foods as part of the production process and/or through alternative means. Notwithstanding these past efforts, there remains a need to provide, through means that go beyond those currently available, a low-moisture pet food with a high degree of palatability. Although a dry product is extremely convenient and exceptionally nutritious, its inherent low palatability has continuously required and relied on the inclusion or application of additives or ingredients to increase the product's palatability but without reducing its nutritive properties.

Algae, which have a high protein content (50 to 60% of dry matter in Chlorella and Scenedesmu, the most widely studied algal species), are a rich source of carotene, vitamin C and K, and B-vitamins. Physiological responses in nutritional studies have suggested that marine unicellular algae can be used as a nutritional source for omega-3 polyunsaturated fatty acids (PUFA), which are known to result in many beneficial health effects on neural and visual development and the prevention of diseases.

Historically, there has been no indicator of “application quality” for a given algal meal during processing. This invention provides a detailed understanding of the protein-derived textural structures and flavor that form as algal biomeal is transformed into processed products and the kinetics associated therewith. This is immediately applicable to improving the practices in the bioconversion industry and lays the groundwork for identity preservation for different algae varieties that produce nutritious biomeal with specific niche applications and markets.

U.S. Pat. No. 4,410,551, incorporated herein by reference, discloses an intermediate-moisture pet food that forms a gravy mixture upon the addition of a warm, aqueous liquid.

U.S. Pat. No. 6,379,727, incorporated herein by reference, discloses a system for selectively providing varied flavor in a pet food diet.

U.S. Pat. No. 5,786,382, incorporated herein by reference, discloses scent-attractants that are used in pet food-products as a means of enticing and exciting canines and felines.

US Patent Publication No. 20010002272, incorporated herein by reference, discloses methods and compositions for enhancing the palatability of dry and semi-dry cat food.

US Patent Publication No. 20030072857, incorporated herein by reference, discloses animal feed containing steam-flaked or steam-rolled grains.

US Patent Publication No. 20040076718, incorporated herein by reference, discloses a dry pet food with increased palatability.

US Patent Publication No. 20050037108, incorporated herein by reference, discloses compositions and methods for enhancing the palatability of dry and semi-dry cat food.

US Patent Publication No. 20050106285, incorporated herein by reference, discloses ingestible compositions having increased palatability for animals, whereby a superior palatability enhancer is used as a component or as a coating.

US Patent Publication No. 20050276881, incorporated herein by reference, discloses a palatability enhancer for cat food.

US Patent Publication No. 20060034978, incorporated herein by reference, discloses aerosol compositions, devices, and methods for improving the flavor or palatability of an animal feed or to provide additional calories or other nutritive benefit.

Animal food manufacturers, the consumer and companion animals, specifically cats, continue to seek dry pet food that is palatable. This requirement perpetuates the need for new and improved compositions and methods for further enhancing the palatability of dry and semi-dry cat food and other pet foods. It would be desirable to provide a natural palatability enhancer at a relatively low production cost, that is convenient to store and use, that has a long shelf life, and that is amenable to varying formulations and flavors and applications. It would also be desirable if the palatability enhancer is nutritionally neutral in that it does not adversely impact or otherwise compromise the nutritional quality or other characteristics of the underlying pet food, does not accelerate the oxidation of fats or contribute extra sodium or other potentially problematic additives to the animal's diet.

### SUMMARY OF THE INVENTION

In view of the foregoing, an embodiment of the invention provides a pet food product to improve the palatability of animal foods and provide highly palatable, functional pet treats through use of algal biomeal. DHA is a structural building block of neurological membranes and is found in high concentrations in neurological tissue.

It is another object of the present invention to provide animal food palatability enhancers that are microalgae-based (include essential polyunsaturated omega-6 long chain fatty acid), all natural/organic (human grade food quality), and nutritionally neutral (having no adverse impact on food).

It is yet another object of the invention to produce palatability enhancers for consumer use that are rancid resistant (long life on dry food), absorption resistant (dry food retains original texture), and slightly viscous (clings to dry food).

It is yet another object of the invention to provide a process and composition that can be conveniently applied to or incorporated into a base pet food having any moisture content by animal food manufacturers, as well as by pet owners without the need for elaborate or complex processing equipment, to improve the palatability and flavor thereof.

It is yet another object of the invention to provide a system, suitable for home use, whereby a pet owner can conveniently and economically provide a flavor-varied diet for a household pet.

The above and other objects are accomplished in accordance with the present invention, which comprises a palatability enhancing system for pet food products based on an algal biomeal-derived dry or moist composition. The composition, which may be flavored, may be topically applied to a dry or moistened pet food to enhance the palatability thereof. In addition to use in feeding (use on food), the all-natural products from contaminant-free, sustainable sources may be applied directly to the animal (to encourage grooming) and to encourage exercise by the animal (use on or in toys).

This invention relates to an animal food composition comprising a basal animal food composition and an algal biomeal-based palatability enhancer, in dry, granular, oil, liquid or aerosol form, suitable for convenient topical application to or incorporation in a base pet food product. The DHA-rich biomeal palatability enhancer may be in the form of a flavored composition. A method of enhancing the palatability of a pet food composition comprises adding or applying the biomeal palatability enhancer to the pet food composition. The algal biomeal also may be included in pet treats.

Dry or low moisture content pet food products (typically less than 15% moisture by weight) have a dry, crunchy texture and generally the lowest production cost, highest nutritional content, least expensive packaging, and greatest convenience in terms of storage and use. However, they are the least palatable. Semi-moist (i.e., semi-dry) or intermediate moisture content products (typically about 15% to 50% moisture by weight) generally have a nutritional value higher than canned food and are easier and less expensive to package and more convenient to use. However, they may be more susceptible to bacterial contamination than dry pet foods, and are generally less palatable than high moisture content foods although more palatable than dry food. Canned or high moisture content products (typically greater than 50% moisture by weight and often around 70%) are usually all-meat products and therefore generally the most highly palatable to the animal. However, such foods are typically costly to produce and package, require the use of preservatives to inhibit decomposition and contamination, and are relatively less nutritious per unit weight than other pet food products.

Dry pet food products are widely marketed for pets and are normally well accepted by cats, dogs, rodents, and other domestic and exotic pets as are known in the art. Dry foods are generally preferred by manufacturers and animal caretakers alike because of their convenience and their higher nutritional value when compared, on an equal weight basis, when compared to semi-moist and canned foods. This nutritional benefit is attributable to dry food's relatively low moisture content, which permits inclusion of a wider variety of ingredients, a better nutritional combination of ingredients, and long term product stability.

Algal sources have recently been used to produce the omega-3 fatty acid (docosahexaenoic acid) (DHA) as a dietary supplement. DHA produces from algal sources as found in infant formulas and related products. Martek® Biosciences Corporation, Columbia, Md., produces and markets DHA products. A by-product of DHA production from algal culture is a protein-rich, delipidated waste material called biomeal (referred to herein above as algal biomeal).

The invention provides for a palatability enhancer having a balance of protein and carbohydrates for terrestrial and aquatic animal diets which comprises all natural delipidated algal or microbial biomeal; preservative-free substrate, highly stable; ranges from fine particles of less than 5 microns to small granules of 500 microns; and wherein the palatability enhancer is a potent attractant for some species.

Food/feed manufacturers have devoted extensive efforts to prevent lipid oxidation in foods. Oxidation of PUFA results in the rapid loss of desirable sensory attributes, which is onset by the accumulation of hydroperoxides and their subsequent secondary products. Effective control mechanisms must be incorporated into products or processes containing omega-3 PUFA to retard oxidative deterioration.

In most processed foods/feeds, lipids are found as oil-in-water or water-in-oil emulsions. The oxidation of emulsified lipids is mechanistically different than bulk oils due to the properties of the emulsion droplet interface and the ability of pro-oxidants, antioxidants and oxidizable substrates to partition into the oil, interface, and water phases of the emulsion. In emulsion type products, the organization of the lipid molecules within the system, as well as their interactions with other types of molecules in their immediate vicinity, has a pronounced influence on their susceptibility to oxidation. Antioxidant effectiveness is also considerably different for bulk oils than food emulsions. Therefore, in order to provide a better understanding of the functional attributes of algal biomeal, an in-depth texture and flavor profiling is needed.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### DETAILED DESCRIPTION OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

In one embodiment, the animal food palatability enhancing composition of the present invention has a manufactured edible substrate comprising a texture, a delipidated microbial biomeal, wherein the delipidated component comprises about 2% to about 4% docosahexaenoic acid (DHA) by weight and wherein the palatability enhancer improves palatability of animal food products. The composition of the embodiment further comprises a texture selected from one of the following: a dry texture, a wet texture, a powder texture, an oily texture and a granular texture. The texture characteristic of the present invention further comprises fine particles of less than 5 microns to small granules of 500 microns. The texture characteristics of the present invention can be optimized to improve mixing characteristics of the present invention either as an additive to existing pet foods, dry or wet, or for production purposes in the manufacture of specialty treats or enhanced animal food products. The fermented microbes from which the microbial biomeal is made include: Dinophyceae, Bacillariophyceae, Chlorophyceae, Prymneniophyceae, Euglenophyceae, Thraustochytrium, Schizocytrium, and combinations thereof. More specifically, the biomeal is a fermentation and processing by-product of Crypthecodimium cohnii. Moreover, the composition of the present invention may or may not comprise a yeast product.

In yet another embodiment of the present invention, the food palatability enhancing composition comprises a delipidated microbial or algal biomeal which comprises less than two percent (2%) DHA by weight.

Another embodiment of the present invention provides for a method of making a palatability enhancer suitable for use in animal food products comprising: fermenting a microbial culture under suitable conditions for cell growth; delipidating the microbial culture to produce a delipidated biomeal by-product; and combining the delipidated biomeal by-product with a manufactured edible substrate to produce a palatably enhanced animal food product. The step of combining in the present invention includes but is not limited to at least one of the following: blending, homogenizing, emulsifying, compressing by way of example. The animal food product may be further processed and handled by refrigerating the palatably enhanced animal food product; freezing the palatably enhanced animal food product; heating the palatably enhanced animal food product; and dehydrating the palatably enhanced animal food product. The delipidated biomeal of the present embodiment can comprise about 2% to about 4% docosahexaenoic acid (DHA) by weight. In yet another embodiment the delipidated component comprises less than two percent (2%) DHA by weight. The method is adapted to form a product which comprises a texture selected from one of the following: a dry texture, a wet texture, a powder texture, an oily texture and a granular texture. Moreover, the particle size may range from less than 5 microns to granules of 500 microns or more.

In yet another embodiment the method involves the use of a delipidated microbial biomeal which comprises a by-product of fermentation of microbes, wherein the microbes comprise at least one of the following: Dinophyceae, Bacillariophyceae, Chlorophyceae, Prymneniophyceae, Euglenophyceae, Thraustochytrium, Schizocytrium, and combinations thereof. More specifically, the by-product of fermentation comprises Crypthecodimium cohnii. The method steps also include mixing, extruding or co-extruding, molding, forming, dehydrating, or packaging said animal food product.

Yet another embodiment of the invention further provides for a method for in-line process control for manufacturing specialty animal treats which have increased palatability comprising: developing products with improved nutrition, texture, and flavor; characterizing quality indicators for microbial algal biomeal end uses; controlling product development and quality traits; and utilizing aquaculture products or by-products.

The method of the present embodiment, wherein the products used further comprise a delipidated algal biomeal which includes algal biomeal produced from cultures of the following organisms such as Dinophyceae, Bacillariophyceae, Chlorophyceae, Prymneniophyceae, Euglenophyceae, Thraustochytrium, Schizocytrium, and combinations thereof.

A palatability enhancer (also referred to herein as flavor enhancer) for animal food is an additive that provides an aroma, taste, aftertaste, mouth feel, texture, and/or organoleptic sensation that is appealing to the target animal. Palatability refers to the overall willingness of the animal to eat a certain food.

Described herein are palatability enhancers for animal foods that use all-natural, preservative free algal biomeal as a core ingredient. The present invention results in high quality palatants and other pet food products, such as specialty treats. The biomeal palatability enhancers, in dry, granular, liquid or aerosol form, are suitable for convenient topical application to or incorporation in a base pet food product and may be formulated as flavored compositions.

The flavoring system (i.e. palatability enhancer or palatability enhancer composition) of the present invention can be applied to a base pet food product, such as a dry pet or animal food. The palatability enhancer of the present intention includes various moist, oily, powdered or granular flavor additive compositions, such as ones derived from fish. In an alternate embodiment, the additive composition may be in the form of a sauce that may be poured over the cat food. In yet another embodiment, the palatability enhancer can be in aerosolized or oil form, with the flavor additive composition sprayed on a base pet food from commercial sprayers or consumer packaging. In addition to topical application, the palatability enhancers, in any form, may be incorporated into the pet food as part of the manufacturing process.

An example sauce packaging system of the present invention consists of sealed individual serving packages of foil, plastic, paper, or other material. Each package is suitable for one meal based on a recommended typical serving of dry cat food for an average size, healthy adult cat. In addition to palatability enhancing sauces, DHA-rich pet food products may include gnawing sticks, bite-sized snacks, oil-based and aerosolized liquids and bottled dry material for sprinkling.

In an embodiment of the invention, monitoring means to record and monitor the applicability of specific composition characteristics in algal biomeal to ensure consistent product quality. In yet another embodiment, the invention provides for development of designer's biomeal premix that can be used in a wide variety of food, feed, and non-food applications. In yet another embodiment of the invention, the invention provides for an algal biomeal screening.

Yet another embodiment of the invention relates to an in-line process control for manufacturing of specialty treats comprising developing products with improved nutrition, texture, and flavor; characterizing of quality indicators for algal biomeal end uses; and improving control of product development and resultant quality traits and further added-value utilization of aquaculture products and/or by-products.

The invention will be further described by reference to the following examples, which are presented for the purpose of illustration only and are not intended to limit the scope of the invention.

Unless otherwise indicated, all amounts are listed as parts by weight. The invention will be further described by reference to the following examples, which are presented for the purpose of illustration only and are not intended to limit the scope of the invention.

TABLE 1
Proximate Composition % by weight

| | | |
|---|---|---|
| Carbohydrate | >40 | mm |
| Moisture | <8 | max. |
| Protein | >25 | mm. |
| Fat | >5 | mm. |
| Fiber | <2 | max. |
| Ash | <16 | max. |
| DHA | >2 | mi |

| | |
|---|---|
| Glycine | 6.12 |
| Aspartic acid | 9.76 |
| Serine | 5.26 |
| Glutamic acid | 15.14 |
| Proline | 4.36 |
| Hydroxyproline | 0.19 |
| Alanine | 7.28 |
| Tyrosine | 3.19 |

### Example 1

### Analytical Characterization of Biomeal

The mechanisms by which chemical constituents interact and flavor forms will be understood in the value-added bioconversion of agriculture and aquaculture products. Ways in which key constituents in the fermented algal biomeal can be modified to fit various texture and flavor specifications will be understood as a revolution in possible applications as pet food palatants and specialty treats for pets, as well as in chemical or pharmaceutical industries. The nutritional value in all-natural, preservative-free algal biomeal will be characterized thus allowing for rational engineering of the formulation of pet food palatants and specialty treats for pets, with optimal texture and flavor quality performance. The relationship between composition profile and sensory properties will be identified and characterized with regard to in-depth texture and flavor merits and sensory quality. The large quaternary protein structure during mixing and heating processes will be formed and characterized. It has been established that protein conformation is crucial in the texture characteristics of and directly affects the product quality. The structure of protein in algae, its complexity, and variation in polymer size and composition will be understood. Protein forms a three-dimensional network during the mixing process, but the cross-links that will form are attributed solely to disulfide bonds, which can only occur at the N- and C-termini of the proteins involved. Many protein structural studies, as well as mixing and heating studies have postulated that disulfide bonds are present and contribute to the general process of structure formation. Several different cross-links will be formed when protein-rich ingredients are processed into food and feed.

While oils rich in long-chain omega-3 PUFA (polyunsaturated fatty acids) containing EPA (eicosapentaenoic acid) and DHA derived from algae are widely recognized for their nutritional importance, lipid oxidation limits their utilization in processed foods and as nutritional supplements (because it leads to development of undesirable “off-flavors” in food and feed products). Lipid oxidation will be minimized by using delipidated microbial biomeal.

Determining key constituents critical to the texture attributes and flavor traits of pet treats requires the characterization of algal biomeal. Characterizing the amino acid, fatty acid, and carbohydrate constituents of algal biomeal is fundamental to understanding the behavior of biomeal under different pH, temperature, and oxygen levels. Concomitant with this is analysis of key quality parameters, including solubility, density, water binding capacity, and volatile compound stability, and the biomeal's oxidative stability.

Baseline data on key biomeal properties, including emulsification ability, serve as the starting point when considering formulation of pet treats. Formulation considerations include decisions about incorporation of algal biomeal with other base ingredients (all natural) such as starch, and determination as to whether use of emulsifiers or binding agents is necessary.

### Example 2

### Processing of Algal Biomeal to Produce a DHA-Rich Fraction Suitable for Use in Pets Foods, Snack and Flavor Enhancers

Algal biomeal will be hydrolyzed, homogenized, emulsified, heated, pressed, or combinations of two or all to produce a DHA-rich fraction. Water and other base ingredients such as starch, protein, and oil will be incorporated under proper conditions, the fraction carries from light to strong flavors and can be in different shades of color. The fraction will be prepared in powder, semi-solid or concentrated liquid form that is readily applicable in the formulation of pet foods, snack and flavor enhancers.

The final formulation effort will involve the adjustments and modification of ingredients to achieve desired flavor, texture and aroma. The fraction will be used for oil-based or water-based products as a flavoring aid and texture enhancer while serving as a good source for DHA that elevates the health benefits to pets.

### Example 3

### Formulation of Specialty Treats Based on the Texture and Flavor Interactions between Biomeal Constituents and other Major Ingredients

The formulation of specialty treats will be performed by identifying the proper usage level of algal biomeal based on biomeal flavor intensity and water binding capacity. Additional ingredients will be carefully chosen according to the nutritional value desirable and verified with the animal nutrition expert suitable for an animal's medical, nutritional and dietary needs. The texture attributes such as hardness, cohesiveness, chewiness, and adhesiveness will be assessed by a texture analyzer. The flavor profile will be constantly monitored to ensure it is comparable to leading commercial products. Sensory evaluation will be utilized to assess the smell and flavor quality of the product as well as consumer acceptance. With the water activity (a_{w}) of the treats carefully controlled at less than 0.85, the microbial safety and quality of specialty treats will stay stable under room temperature for a reasonable period of time. By employing adequate packaging (including but not limited to plastic packets, jars, cans and other packaging or containers as are known in the art), an extended shelf life will be achieved.

### Example 4

### Formulation of Sauces and Powders Suitable for Use as Pet Food Enhancers

The formulation of sauces and powders suitable for use as pet food enhancers will be performed by identifying the proper usage level of microbial or algal biomeal based on biomeal flavor intensity and water binding capacity. Additional ingredients will be carefully chosen according to the nutritional value desirable and verified within an animal's predetermined nutritional needs. The texture attributes of the sauce such as viscosity, consistency, surface tension (i.e. a balance between cohesiveness and adhesiveness of the fluid) will be assessed and standardized by using Brookfield viscometer, Bostwick consistometer, and tensiometer. The density, porosity, solubility, and hygroscopicity (i.e. the ability to absorb moisture in the environment) of the powders will be determined. The flavor profile will be constantly monitored to ensure it is comparable to leading commercial products. Sensory evaluation will assess the smell and flavor quality of the product as well as consumer acceptance.

With the viscosity and consistency of the sauce under control, formulations of moist products will be easily prepared. The microbial safety and quality of the sauce will be assessed to determine proper suggested shelf life. The powders, on the other hand, can stay stable under room temperature for a reasonable period of time. By employing adequate packaging, an extended shelf life can be achieved.

### Example 5

### Optimization, Modification, and Verification of the Formulation to Ensure the Overall Nutrition Quality, Microbial Safety, and Shelf Life Stability of the Specialty treats, Sauce, and Powders

The formulations for DHA-enriched pet snacks, sauces, and powders of Examples 3 and 4 will be subjected to continuous optimization and modification to develop a quality product. The formula will be verified to meet the nutrition requirements so that it can become a healthy treat using all-natural ingredients. The water activity, a key parameter in determining microbial safety of the treats, will be measured in concert with total plate count to establish the base of shelf life. An accelerated shelf life study will be conducted to project the texture and flavor stability of the product. The effects of pH, temperature, and oxygen are identified and monitored, and taken into consideration when making packaging recommendations.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

We claim:

1. An animal food palatability enhancing composition comprising:
a manufactured edible substrate comprising a texture; and
a delipidated microbial biomeal, wherein said delipidated component comprises about 2% to about 4% docosahexaenoic acid (DHA) by weight and wherein said palatability enhancer improves palatability of animal food products.

2. The composition of claim 1, wherein said texture further comprises a texture selected from one of: a dry texture, a wet texture, a powder texture, an oily texture and a granular texture.

3. The composition of claim 1, wherein said texture comprises fine particles of less than 5 microns to small granules of 500 microns.

4. The composition of claim 1, wherein said delipidated microbial biomeal comprises a by-product of fermentation of microbes, wherein said microbes comprise at least one of:
Dinophyceae, Bacillariophyceae, Chlorophyceae, Prymneniophyceae, Euglenophyceae, Thraustochytrium, Schizocytrium, and combinations thereof.

5. The invention of claim 4, wherein said by-product of fermentation of microbes comprises Crypthecodimium cohnii.

6. The composition of claim 1, wherein said delipidated microbial biomeal does not comprise a yeast.

7. An animal food palatability enhancing composition of claim 1 comprising:
a manufactured edible substrate comprising a texture; and
a delipidated microbial biomeal, wherein said delipidated microbial biomeal comprises less than 2% DHA by weight,
wherein said palatability enhancer improves palatability of animal food products.

8. A method of making a palatability enhancer of claim 1 suitable for use in animal food products comprising:
fermenting a microbial culture under suitable conditions for cell growth;
delipidating said microbial culture to produce a delipidated biomeal by-product; and
combining said delipidated biomeal by-product with a manufactured edible substrate to produce a palatably enhanced animal food product, wherein said combining comprises selected from at least one of: blending, homogenizing, emulsifying, compressing.

9. The method of claim 8, wherein said method further comprises any one of:
refrigerating said palatably enhanced animal food product;
freezing said palatably enhanced animal food product;
heating said palatably enhanced animal food product; and
dehydrating said palatably enhanced animal food product.

10. The method of claim 8, wherein said delipidated component comprises about 2% to about 4% docosahexaenoic acid (DHA) by weight.

11. The method of claim 8, wherein said delipidated component comprises less than 2% DHA by weight.

12. The method of claim 8, wherein said texture further comprises a texture selected from one of: a dry texture, a wet texture, a powder texture, an oily texture and a granular texture.

13. The method of claim 8, wherein said granular texture comprises fine particles of less than 5 microns to small granules of 500 microns.

14. The method of claim 8, wherein said delipidated microbial biomeal comprises a by-product of fermentation of microbes, wherein said microbes comprise at least one of:
Dinophyceae, Bacillariophyceae, Chlorophyceae, Prymneniophyceae, Euglenophyceae, Thraustochytrium, Schizocytrium, and combinations thereof.

15. The method of claim 8 wherein said by-product of fermentation comprises Crypthecodimium cohnii.

16. The method of claim 8, further comprising at least one of:
mixing said animal food product;
extruding said animal food product;
molding said animal food product;
forming said animal food product;
dehydrating said animal food product; and
packaging said animal food product.

17. A method for optimizing palatable components of microbial biomeal comprising:
fermenting microbial aquaculture products;
lysing microbial cells;
extracting natant lipids to produce a waste product, wherein said microbial biomeal;
elucidating the mechanisms of the chemical constituents in microbial aquaculture products;
modifying said microbial biomeal to fit predetermined texture and flavor specifications;
characterizing a nutritional value of said microbial biomeal;
wherein formulation of pet food palatable components are modified.

18. The method of claim 17, wherein said delipidated microbial biomeal comprises a by-product of fermentation of microbes, wherein said microbes comprise at least one of:
Dinophyceae, Bacillariophyceae, Chlorophyceae, Prymneniophyceae, Euglenophyceae, Thraustochytrium, Schizocytrium, and combinations thereof.

19. The invention of claim 17, wherein said by-product of fermentation of microbes comprises Crypthecodimium cohnii.

20. The method of claim 17, wherein said characterizing further comprises identifying the relationship between a composition profile and sensory properties of said palatable components.

21. The method of claim 17, wherein said palatable components comprise a texture wherein said texture further comprises a texture selected from one of: a dry texture, a wet texture, a powder texture, an oily texture and a granular texture.

22. A method for in-line process control for manufacturing specialty animal treats comprising:
developing products with improved nutrition, texture, and flavor;
characterizing quality indicators for a microbial algal biomeal end uses;
controlling product development and quality traits; and
utilizing aquaculture products or by-products.

23. The method of claim 22, wherein said products further comprise a delipidated algal biomeal.

24. The method of claim 23, wherein said delipidated algal biomeal comprises at least one of:
Dinophyceae, Bacillariophyceae, Chlorophyceae, Prymneniophyceae, Euglenophyceae, Thraustochytrium, Schizocytrium, and combinations thereof.
